(19) United States
(12) Patent Application Publication
(10) Pub. No.: US 2008/0211216 A1
(43) Pub. Date: Sep. 4, 2008

(54) Coupler for a Vehicle Accessory

(75) Inventor: Patrick Fortin, Thetford Mines (CA)

Correspondence Address: SUTHERLAND ASBILL & BRENNAN LLP, 999 PEACHTREE STREET, N.E., ATLANTA, GA, 30309, US

(73) Assignee: RAD TECHNOLOGIES INC., Thetford Miles (CA)

(21) Appl. No.: 12/040,219

(22) Filed: Feb. 29, 2008

Related U.S. Application Data
(60) Provisional application No. 60/892,697, filed on Mar. 2, 2007.

(51) Int. Cl. B62D 49/06; A01D 34/00; F16D 1/10

(52) U.S. Cl. 280/760; 56/10.1; 403/306

(57) ABSTRACT

A coupler assembly for coupling an accessory to a vehicle chassis. The coupler assembly includes a male portion having a male attachment end and a conical male portion, the male side walls each having a male pin aperture, a female portion having a female attachment end and a conical female portion, the conical female portion adapted to at least partly receive the conical male portion, the female side walls each having a female pin aperture, the female pin apertures adapted to be aligned with the male pin apertures when the conical male portion is at least partly received in the conical female portion and two pins adapted to be displaced from a retracted configuration wherein the pins are one of fully contained within the conical male portion and outside the conical female portion and an extended configuration wherein the tip ends of the pins extend through both the male pin apertures and the female pin apertures when the conical male portion is at least partly received in the conical female portion. The male conical portion may include a double pin displacement mechanism adapted to displace the pins to one of the retracted configuration and the extended configuration.

### CROSS-REFERENCE TO RELATED APPLICATIONS

This application claims priority under 35 USC §119(e) of U.S. provisional patent application No. 60/892,697, filed Mar. 2, 2007, the specification of which is hereby incorporated by reference.

### TECHNICAL FIELD

The invention relates to couplers to attach accessories to vehicles, such as, couplers to attach heavy accessories, such as snow plows, to the front or back of a tractor vehicle.

### BACKGROUND OF THE ART

U.S. Pat. No. 4,778,195 concerns a tractor accessory quick hitch. With reference to FIG. 3 of U.S. Pat. No. 4,778,195, the rectangular portion on the left is the portion which is provided on the tractor. It ends in a conical portion 26B, shown in FIG. 7 of U.S. Pat. No. 4,778,195 (male portion). The tractor accessory, for example a snow plow, is provided with a corresponding conical portion 20, as shown in FIG. 1 of U.S. Pat. No. 4,778,195, which is adapted to surround the conical portion of the tractor adaptor (female portion). It is secured therein using a pin which travels from inside the tractor adaptor through a central superior opening of both the conical portion of the tractor adaptor and of the accessory adaptor and back towards the tractor using a handle 40 to be manipulated by an operator. FIG. 7 of U.S. Pat. No. 4,778,195 shows the mechanism used to travel the pin. A safety lock is placed in the pin once in place.

The conical portions allow to easily align the two adaptors together and facilitate hitching of different accessories. The accessory is placed on the ground with the female conical portion of the accessory adaptor ready to receive the male conical portion of the tractor adaptor and the tractor is simply driven forward until the male portion enters the female portion. The operator then exits the tractor and manipulates the handle to secure the accessory in place.

The problems associated with prior art couplers and hitches include vibrations and displacements of the accessory because there is only one anchor point securing the accessory to the tractor, difficulties in aligning the two conical portions to allow the pin to travel through a small opening in each conical portion which must be precisely aligned, strength of the operator needed to bring the pin back toward the tractor and lock the pin in place and deformation of the pin after multiple uses.

### SUMMARY

It is therefore an aim of the present invention to address the above mentioned issues.

According to a general aspect, there is provided a coupler assembly for coupling an accessory to a vehicle chassis. The coupler assembly comprises a male portion, a female portion and two pins.

According to a general aspect, there is provided a male portion for use with a female portion and two pins.

According to a general aspect, there is provided a female portion for use with a male portion and two pins.

The male portion has a male attachment end and a conical male portion, the male side walls each have a male pin aperture.

In an embodiment, the male conical portion also comprises a double pin displacement mechanism adapted to displace the pins to one of the retracted configuration and the extended configuration.

The female portion has a female attachment end and a conical female portion, the conical female portion is adapted to at least partly receive the conical male portion, the female side walls each have a female pin aperture, the female pin apertures are adapted to be aligned with the male pin apertures when the conical male portion is at least partly received in the conical female portion.

The pins are adapted to be displaced from a retracted configuration wherein the pins are one of fully contained within the conical male portion and outside the conical female portion and an extended configuration wherein the tip ends of the pins extend through both the male pin apertures and the female pin apertures when the conical male portion is at least partly received in the conical female portion.

According to a general aspect, there is provided a coupler assembly for coupling an accessory to a vehicle chassis. The coupler assembly comprises: a male member securable to one of the accessory and the vehicle chassis, the male member having a male frame with male side walls and at least one male aperture defined in each of the side walls; a female member securable to the other one of the accessory and the vehicle chassis, the female member having a female frame with female side walls and at least one female aperture defined in each of the side walls, the female frame defining a cavity, the male member being at least partially insertable in the cavity with the male side walls and the female side walls being juxtaposed to one another and the male apertures and the female apertures in registry; and at least one pin insertable in the juxtaposed male and female apertures to secure the male and female members together.

According to another general aspect, there is provided a coupler assembly for coupling an accessory to a vehicle chassis, comprising: a male member having a male attachment end securable to one of the accessory and the vehicle chassis, a conical male portion having a male enlarged end near the male attachment end and an opposed male tapered end, and two pins slidably mounted to the male member, the male tapered end having male side walls with a male pin aperture defined therein, the pins sliding between a retracted configuration wherein the pins are contained within the conical male portion and an extended configuration wherein a tip end of the pins extends outwardly of the conical male portion through a respective one of the male pin apertures; and a female member having a female attachment end securable to the other one of the accessory and the vehicle chassis and a conical female portion having a female tapered end near the female attachment end and an opposed female enlarged end, the female tapered end having female side walls with a female pin aperture defined therein, the conical male portion being at least partly receivable in the conical female portion in an engaged configuration wherein the female pin apertures are in registry with a respective one of the male pin apertures, the pins extending through the male and female pin apertures in the extended configuration thereof to secure the male member and the female member together in the engaged configuration.

According to another general aspect, there is provided a coupler assembly for coupling an accessory to a vehicle chassis, comprising a male portion having a male attachment end and a conical male portion, the male attachment end adapted to be affixed to one of the accessory and the vehicle chassis, the conical male portion having a male enlarged end near the male attachment end and an opposed male tapered end, the male tapered end having male side walls, the male side walls each having a male pin aperture; a female portion having a female attachment end and a conical female portion, the female attachment end adapted to be affixed to the other one of the accessory and the vehicle chassis, the conical female portion adapted to at least partly receive the conical male portion, the conical female portion having a female tapered end near the female attachment end and an opposed female enlarged end, the female tapered end having female side walls, the female side wails each having a female pin aperture, the female pin aperture of the female side walls adapted to be aligned with the male pin aperture of an adjacent one of the male side walls when the conical male portion is at least partly received in the conical female portion; and two pins each having a tip end and a rear end, adapted to be displaced from a retracted configuration wherein the pins are one of fully contained within the conical male portion and outside the conical female portion and an extended configuration wherein the tip ends of the pins extend through both the male pin apertures and the female pin apertures when the conical male portion is at least partly received in the conical female portion.

According to another general aspect, there is provided an accessorized vehicle comprising: a vehicle chassis having one of a male member and a female member mounted thereto; and an accessory having the other one of the male member and the female member mounted thereto; the male member having a male frame with male side walls and at least one male aperture defined in each of the side walls and the female member having a female frame with female side walls defining a cavity and at least one female aperture defined in each of the side walls, the male member being at least partially removably insertable in the cavity in an engaged configuration wherein the male side walls and the female side walls are juxtaposed to one another and the male apertures and the female apertures are in registry, the male and the female members being securable together in the engaged configuration with at least one pin inserted in the juxtaposed male and female apertures.

According to a further general aspect, there is provided a method for coupling an accessory to a vehicle chassis. The method comprises: securing a male member to one of the accessory and the vehicle chassis, the male member having a male frame with male side walls and at least one male aperture defined in each of the side walls; securing a female member to the other one of the accessory and the vehicle chassis, the female member having a female frame with female side walls and at least one female aperture defined in each of the side walls, the female frame defining a cavity; at least partially inserting the male member inside the cavity of the female member with the male side walls and the female side walls being juxtaposed to one another and the male apertures and the female apertures in registry; and engaging a pin in each of the juxtaposed male and female apertures to secure the male and female members together.

### BRIEF DESCRIPTION OF THE DRAWINGS

FIG. 1 is a side perspective view of a coupler assembly which attaches an accessory, in this case a snow plow to a vehicle, in this case a tractor;

FIG. 2 is a side perspective view of the male portion of a prior art coupler;

FIG. 3 is a top perspective view of the prior art male portion of the type of FIG. 2 received in a prior art female portion;

FIG. 4 is a bottom plan view of a male portion of a coupler in accordance with an embodiment, wherein the pins are in a retracted configuration;

FIG. 5 is a bottom plan view of the male portion of the coupler shown in FIG. 4, wherein the pins are in an extended configuration;

FIG. 6 is a top perspective view of the male portion shown in FIG. 4 received in a female portion of the coupler, wherein the pins are in the extended configuration;

FIG. 7 is a bottom plan view of a male portion of a coupler in accordance with another embodiment, wherein the actuator includes a sliding lever in lieu of a rotative handle and wherein the pins are in the retracted configuration;

FIG. 8 is a bottom plan view of the male portion shown in FIG. 7, wherein the pins are in the extended configuration;

FIG. 9 is a top perspective view of the male portion shown in FIG. 7 received in a female portion of the coupler with a displacement aperture, wherein the pins are in the extended configuration;

FIG. 10 is a bottom plan view of a male portion of a coupler in accordance with another embodiment, wherein the pins are spring-loaded pins in the extended configuration and the actuator includes a tapered linkage;

FIG. 11 is a bottom plan view of the male portion shown in FIG. 10, wherein the pins are in the retracted configuration;

FIG. 12 is a bottom plan view of a male portion of a coupler in accordance with another embodiment, wherein the actuator includes a hydraulic or pneumatic component and wherein the pins are in the retracted configuration;

FIG. 13 is a bottom plan view of a male portion of a coupler in accordance with another embodiment, wherein the pins are independent pins received from the outside; and

FIG. 14 is a top perspective view of the male portion shown in FIG. 13 received in a female portion of the coupler, wherein the pins are engaged in the male and the female portions to secure all items in an engaged configuration.

It will be noted that throughout the appended drawings, like features are identified by like reference numerals.

### DETAILED DESCRIPTION

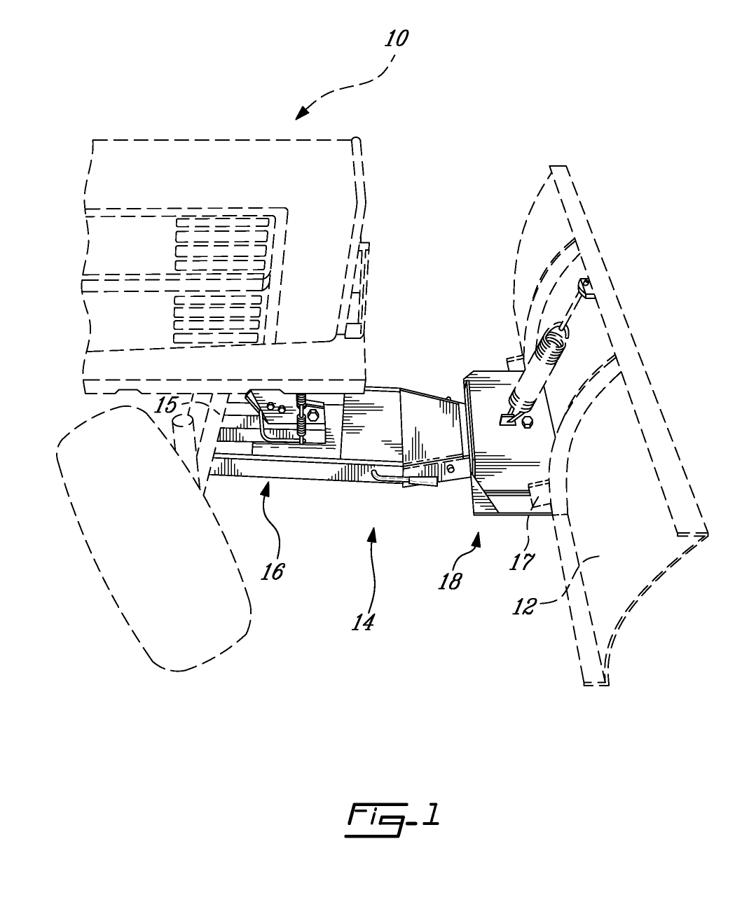

Referring now to the drawings and, more particularly, referring to FIG. 1, it will be seen the front of a vehicle 10, such as a tractor, in this figure, and an accessory, in this figure, a snow plow 12. The coupler 14 is made up of two portions, namely the vehicle portion 16 affixed to the vehicle chassis 15 and the accessory portion 18 affixed to the accessory body 17. The accessory portion 18 comprises of an accessory attachment section for attachment to the accessory body 18 and a conical section, which is the female portion of the coupler 14. The vehicle portion 16 includes a vehicle attachment section for attachment of the vehicle portion to the vehicle chassis and a conical section which is the male portion of the coupler 14 (not shown since it is received in the conical section of the female portion).

As it will be readily understood, the male portion does not need to be affixed to the vehicle and the female portion does not need to be affixed to the accessory. The matching of the portions of the coupler to the vehicle or the accessory could be switched.

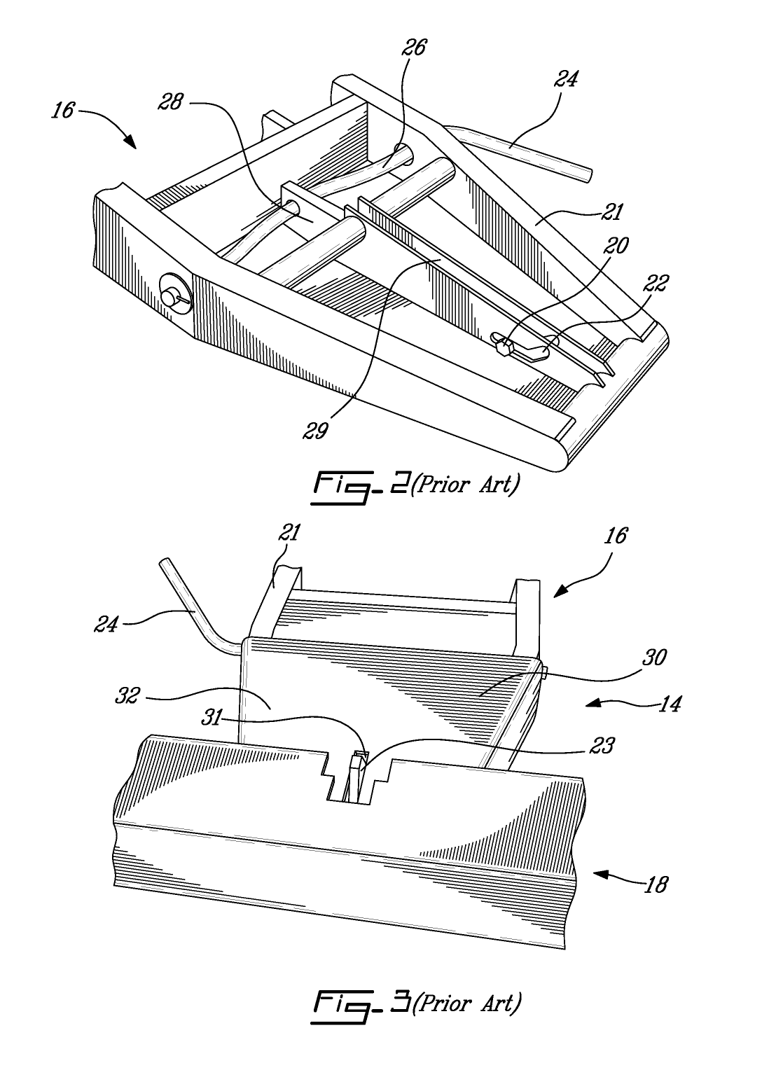

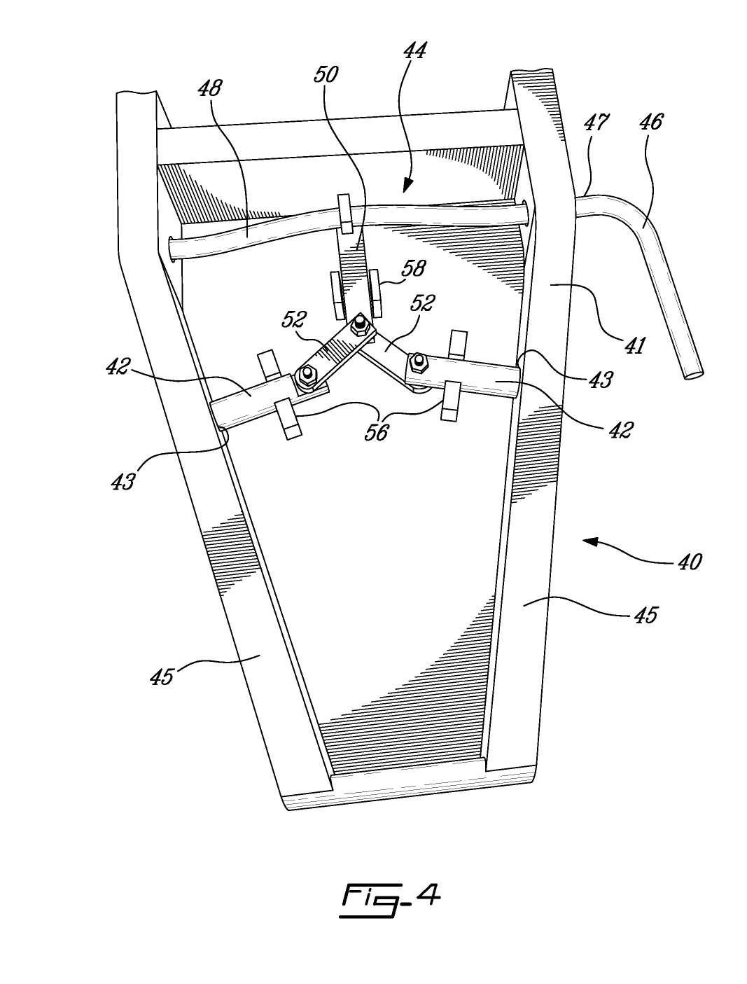

FIG. 2 shows the prior art male portion of the coupler. The pin 20 travels in the guide 22 near the end of the conical portion 21. The handle 24 is affixed to a curved rod 26 which slides a metal piece 28 in a central passage 29 which in turns pushes the pin 20 to travel in the guide 22 and to make a hook or latch bar 23 (FIG. 3) exit the central passage.

FIG. 3 shows the prior art male portion of FIG. 2 inserted in the prior art female portion 30 of the coupler. The female conical portion 30 is adapted to surround the male conical portion 21 of the vehicle adaptor. The handle 24 used to make the hook 23 travel through an opening 31 in both conical portions 21, 30 and exit at the top 32 of the female portion 30. A safety lock (not shown) can be placed in the hook 23 once the two conical portions are coupled.

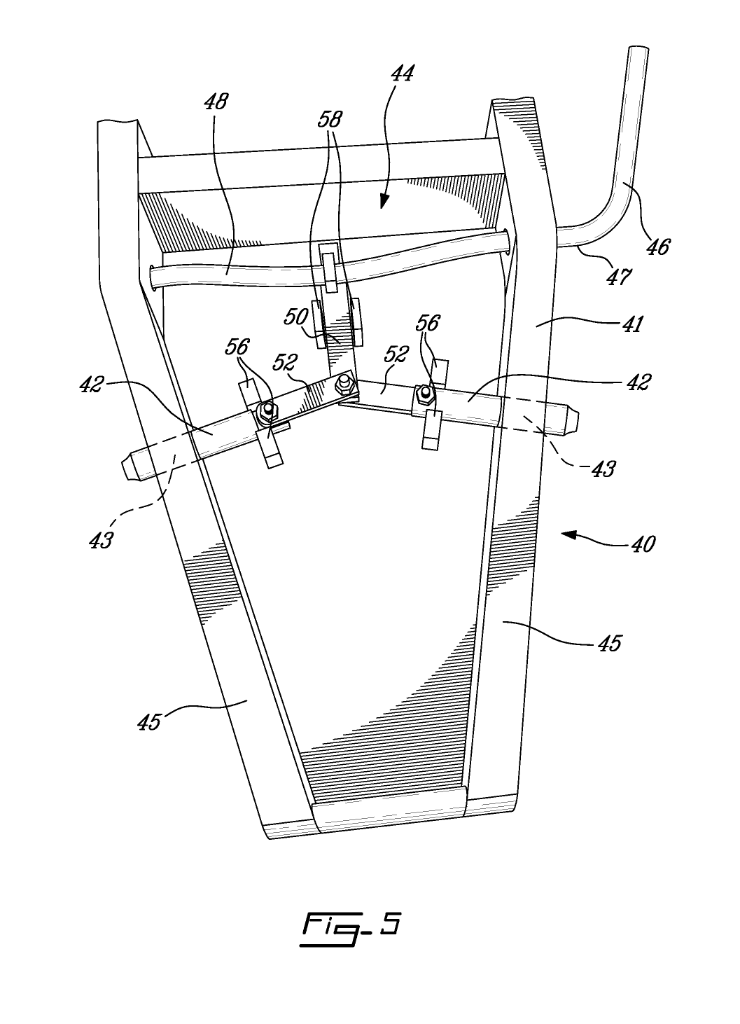

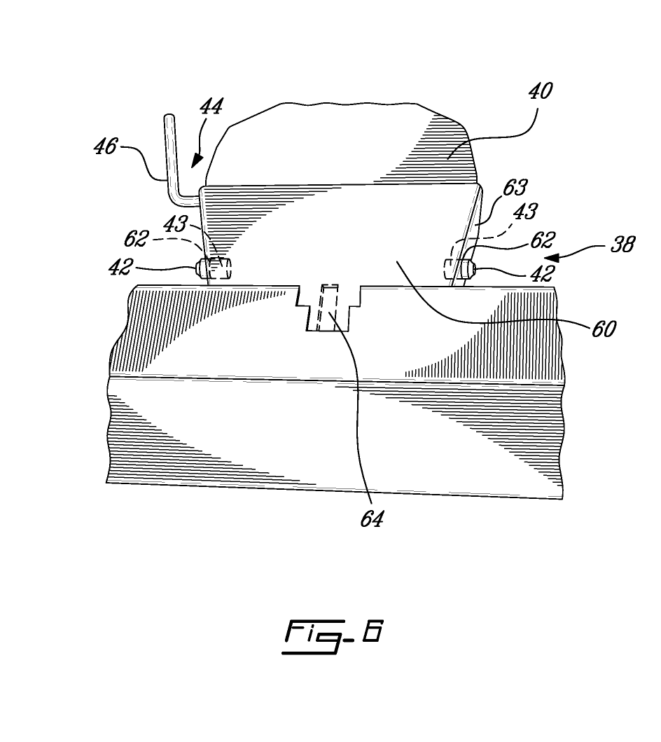

Referring now to FIGS. 4 and 5, it will be seen a male portion 40 of an improved coupler 38. The male portion 40 has a frame 41 with an enlarged end, an opposed tapered end and male side walls 45 extending between both ends to define a substantially conical shape. Male pin apertures 43 are defined in each male side walls 45 and pins 42 are slidingly inserted therein. The pins 42 are slidingly displaceable between a retracted configuration (FIG. 4) and an extended configuration (FIG. 5).

In the retracted configuration (FIG. 4), the tip ends of the pins 42 do not protrude outwardly from the side walls 45 and the male portion 40 can slide freely in and out the female portion 60 (FIG. 6) of the coupler 38. On the opposite, in the extended configuration (FIG. 5), the tip ends of pins 42 protrude outwardly from the side walls 45 and, if the male portion 40 is inserted in the female portion 60, the pins 42 engage the female portion 60, as shown in FIG. 6.

For translating the pins 42 between the retracted and the extended configurations, the coupler 38 includes an double pin actuator 44. The actuator 44 includes a rod 47, a linkage arm 50, and two pivoting arms 52. The rod 47 has a handle section 46 which extends outwardly of the conical section of the male portion 40 and a curved section 48 extending between both side walls 45. The handle section 46 can be seized and manipulated to translate the pins 42 between both configurations and, simultaneously, engaged and disengaged the male and the female portions 40, 60.

The rod 47 can rotate between a distal configuration (FIG. 4) and a proximal configuration (FIG. 5). The curved section 48 of the actuator 44 is connected to a distal end of the linkage arm 50. A first end of two pivoting arms 52 is pivotally mounted to the opposite end of the linkage arm 50 and the pivoting arms 52 extend in opposite directions. The second end of the pivoting arms 52 is pivotally mounted to a rear end of the pins 42. Thus, the rotation of the handle section 48 of the actuator 44 is translated into linear motion of the linkage arm 50, the pivoting arms 52, and the pins 42. In the distal configuration of the actuator 44, the pins 42 are in the retracted configuration (FIG. 4) while in the proximal configuration of the actuator 44, the pins 42 are in the extended configuration (FIG. 5). Translation guides 56, 58, having a groove defined therein in which the linkage arm 50 and the pivoting arms 52 are respectively inserted, are provided to guide the translation movement.

FIG. 6 shows the coupler 38 with the male conical portion 40 received in the female conical portion 60.

As with the male portion 40, the female member has a frame with an enlarged end, an opposed tapered end and female side walls 63 extending between both ends to define a substantially conical shape. Female pin apertures 62 are defined in each female side walls 63 and the pins 42 can be slidingly inserted therein, when the male and female apertures 43, 62 are in registry.

In FIG. 6, the pins 42 are in the extended configuration, i.e. they extended through the apertures 43 defined in the male side walls 45 of the male conical portion 40. The pins 42 are also engaged, i.e. they extends through, with corresponding female apertures 62 of the female conical portion 60. When the pins 42 in the engaged configuration and simultaneously engaged through apertures 43, 62, the accessory is securely hitched to the vehicle and the male portion 40 and the female portion 60 are in an engaged configuration.

Alternatively, the female conical portion 60 can also be provided with a slot 64 to ensure compatibility of the female portion 60 with both the prior art and the improved male conical portions.

The female conical portion 60 is therefore attached to the male conical portion 40 using two opposed pins 42 while keeping the basic concept of the handle which is simple to manipulate for an operator and the conical portions which can easily be aligned and inserted into one another.

With the improved version, a less precise alignment is required, less strength is required by the operator, there is less vibration and shimmy of the accessory.

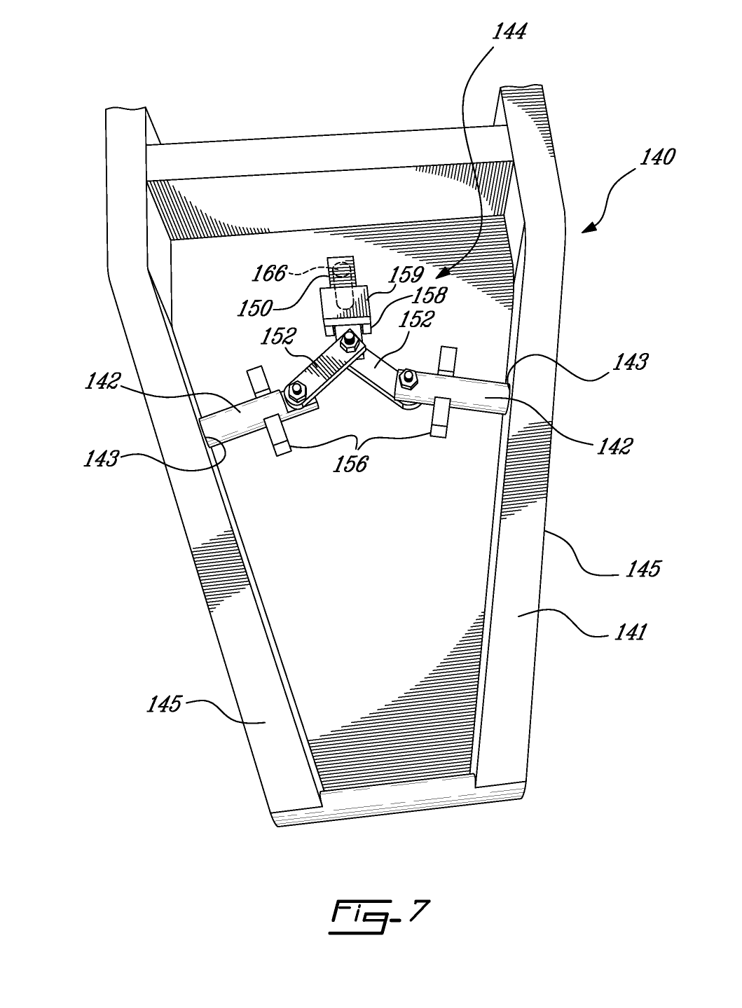

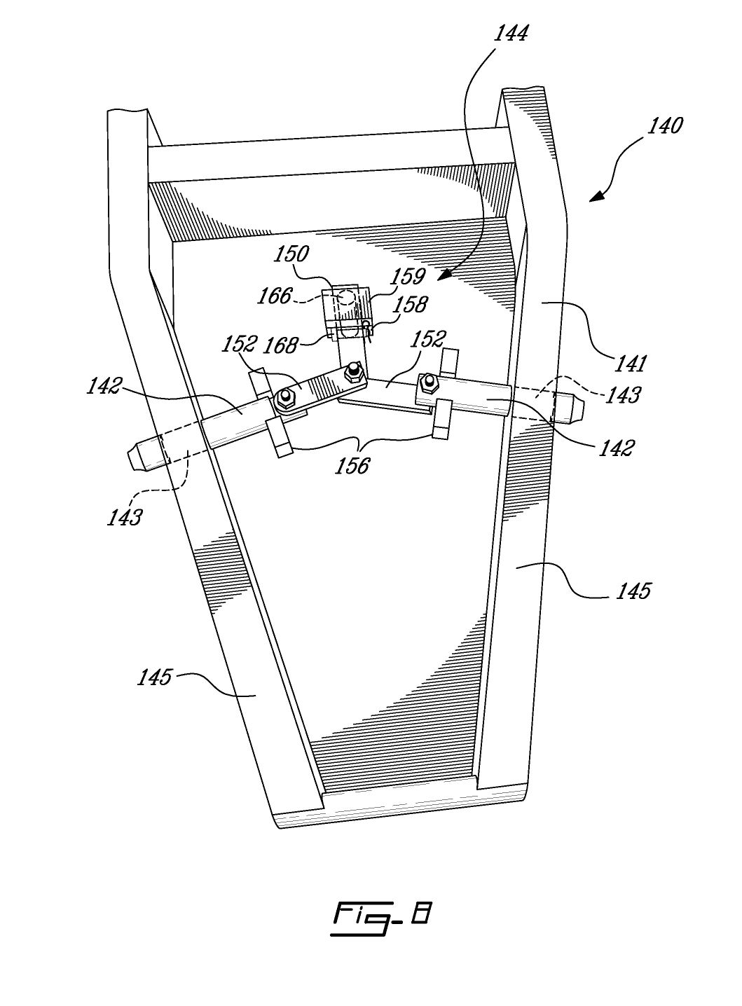

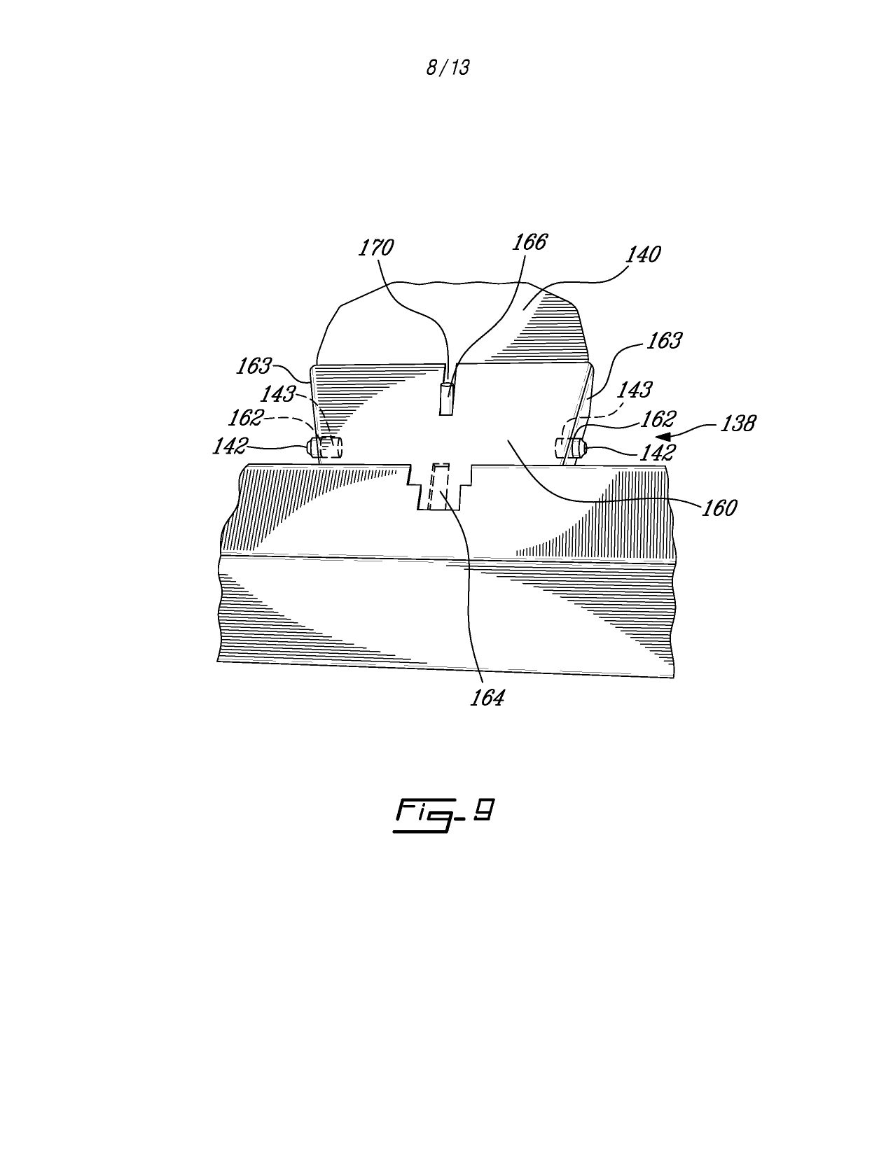

Referring now to FIGS. 7 and 8, there is shown an alternative embodiment to the coupler 38 wherein the double pin actuator 44 is modified. The features are numbered with reference numerals which correspond to the reference numerals of the previous embodiment in the 100 series.

In this embodiment, the linkage arm 150 is not attached to the curved section 48 of a rod 47. On the opposite, it can be directly seized and displaced, by the operator, as a sliding lever, along a translation motion to configure the male portion 140 in the retracted and extended configurations of the pins 142 (FIGS. 7 and 8 respectively). To configure the male portion in the extended configuration (FIG. 8), from the retracted configuration (FIG. 7), the linkage arm 150 is slid towards the front section, i.e the tapered end, of the male portion 140 to place the pins 142 in the extended configuration. The linkage arm 150 is pulled towards the rear section, i.e. the enlarged end, of the male portion 140 to place the pins 142 in the retracted configuration.

In an embodiment, the translation guide 158 can include an upper portion 159 which covers the linkage arm 150 and prevents its removal from the groove. Additionally, the linkage arm 150 can be provided with a handle 166, such as a protuberance, at its end to allow the operator to more easily grab and translate the latter. A safety pin 168 is inserted into linkage arm 150 to secure the pins 142 in the extended configuration and prevent the pins 142 from being displaced back into the retracted configuration upon lateral movement of the coupler 138.

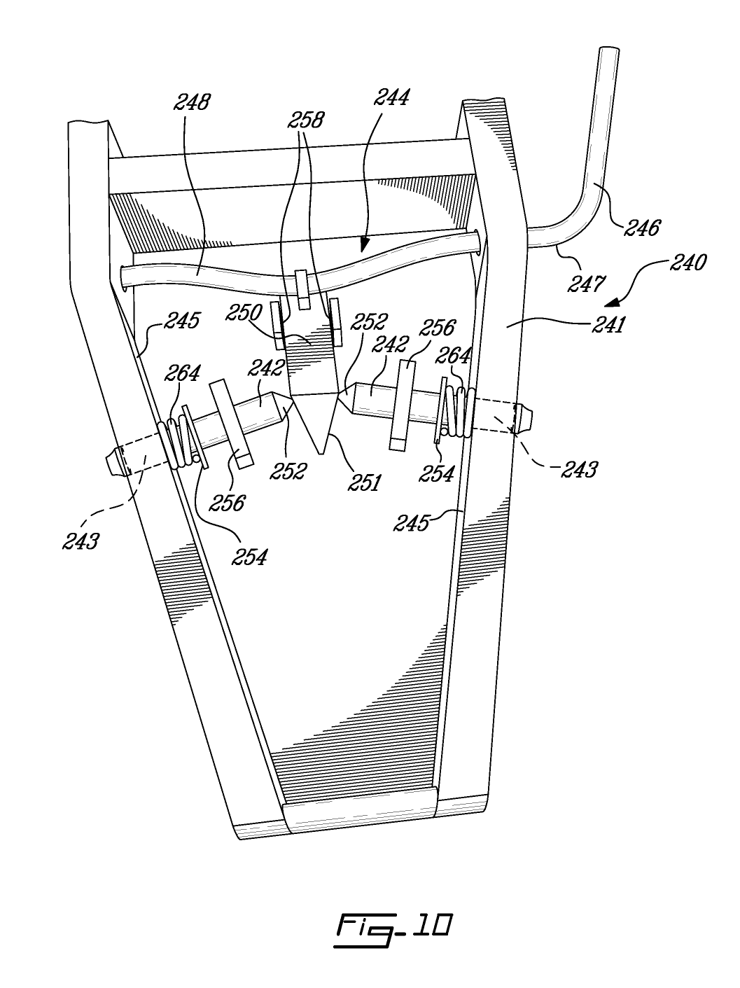

Referring now to FIG. 9, there is shown the male portion 140 of the coupler 138 engaged in the female portion 160 with the pins 142 in the extended configuration, i.e. the pins 142 are simultaneously received in apertures 143, 162 provided in the side walls 145, 163 of the male and female portions 140, 160.

The female portion 160 is similar to the female portion 60 (FIG. 6), except for a displacement aperture 170 allowing the operator to access the linkage arm 150 once the female portion 160 is properly aligned with the male portion 140 in order to translate the linkage arm 150 towards the front section and displace the pins 142 in the extended configuration and insert the safety pin 168. The handle 166, if any, can protrude outwardly through aperture 170 to be easily seized by the operator.

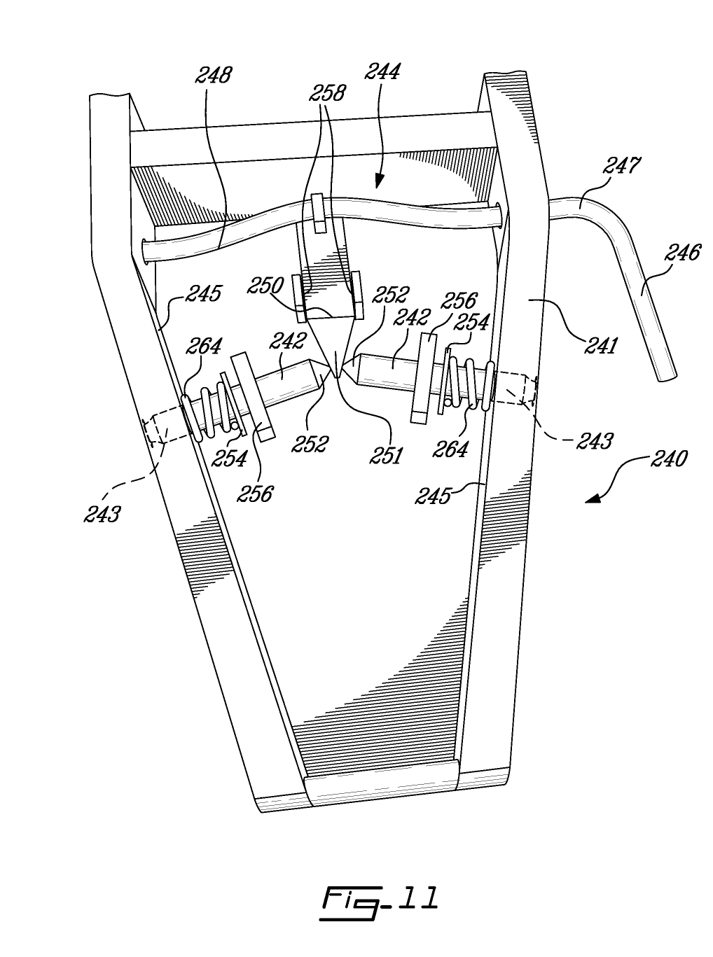

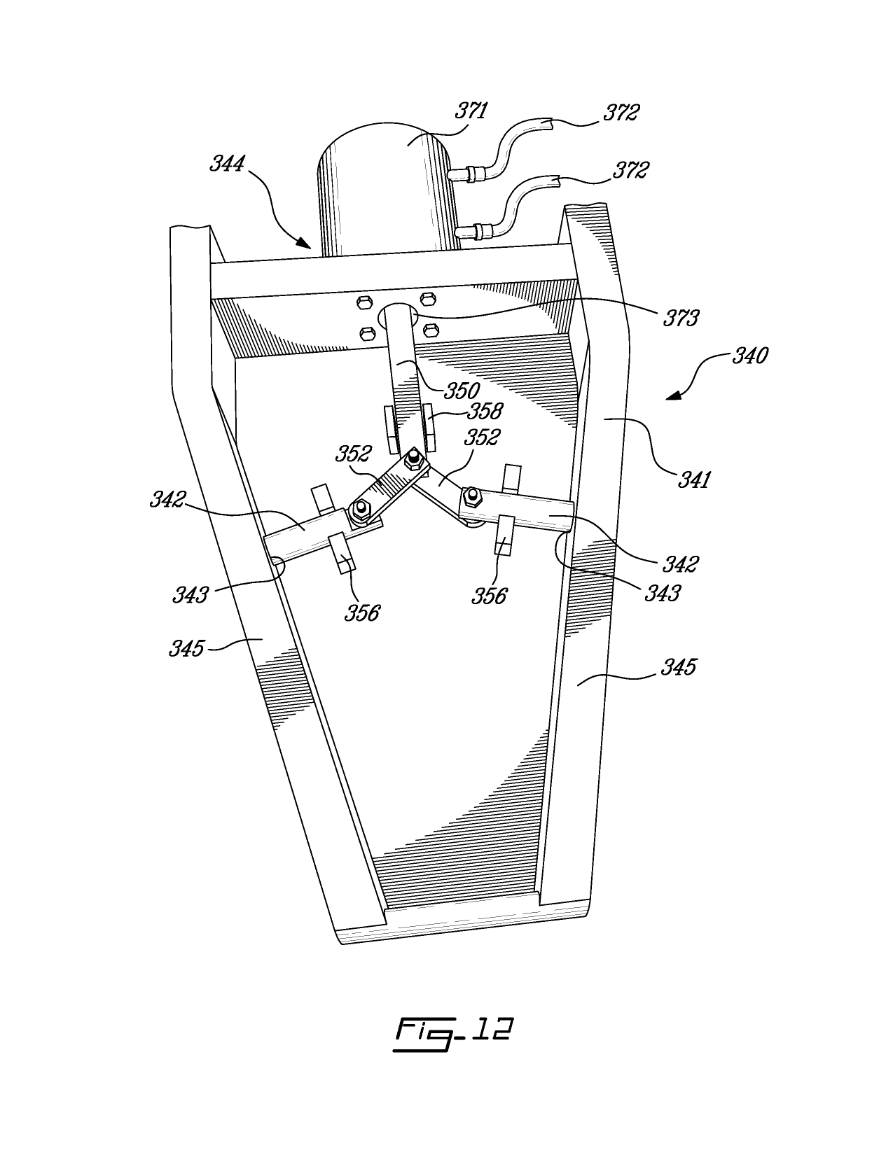

Referring now to FIGS. 10 and 11, there is shown an alternative embodiment to the couplers 38, 138 wherein the linkage arm 50, 150 and the pivoting arms 52, 152 are modified. The features are numbered with reference numerals which correspond to the reference numerals of the previous embodiment in the 200 series.

In this embodiment, the double-pin actuator 44, 144 including the linkage arm 50, 150 and the pivoting arms 52, 152 is replaced by an double pin actuator 244 including a linkage arm 250 with a tapered end 251, opposite to the rod 247, and the pins 42, 142 are replaced by spring-loaded pins 242. Moreover, the straight rear end of pins 42, 142 is replaced by a tapered rear end 252. The tapered end 251 of the linkage arm 250 abuts on the tapered end 252 of the spring-loaded pins 242. It is appreciated that the pins 242 could have a straight rear end; however, the position of the pins 242 having a tapered end 252 is more precisely controlled by the linkage arm 250.

The actuator 244 also includes a rod 247, similar to the one described above in reference to FIGS. 4 to 6. However, it is appreciated that the linkage arm 250 could be directly seized and translated as in the embodiment described above in reference to FIGS. 7 to 9.

Translation guides 256, 258 guide the translation movement of the pins 242 and the linkage arm 250 respectively. Translation guides 256 differ from translation guides 56, 156. Translation guides are plates having a guiding aperture defined therein in which the pins 242 are slidably inserted.

Stoppers 254 can be mounted to the pins 242 and juxtaposed to the spring members 264. The stoppers 254 are designed to abut the translation guides 256 in the retracted configuration of the male portion 240 and prevent the pins 242 to be further retracted in the male portion 240.

The spring members 264 are provided between the side walls 245 of the male portion 240 and the stoppers 254. They are contracted against the male side walls 245 in the extended configuration of the pins 242 and they are in an extended configuration in the retracted configuration of the pins 242, i.e. the stopper 254 abuts against the translation guide 256.

Thus, in the extended configuration of the pins 242 (FIG. 10), the linkage arm 250 is translated towards the front section of the male portion 240 and the tip end 252 of the pins 242 slide towards the largest section (the base) of the linkage arm tapered end 251, which pushes the pins 242 outwardly and compresses the spring member 264.

In the retracted configuration of the pins 242 (FIG. 11), the linkage arm 250 is translated towards the rear section of the male portion 240 and the end 252 of the pins 242 are located at the tip of the linkage arm tapered end 251. The spring member 264 is thus in an uncompressed configuration and the pins 242 are recessed in the frame 241.

In use, and as apparent from comparing FIG. 10 and FIG. 11, rotation of the actuator 244 and, more particularly the handle section 246, makes curved section 248 push or pull on the linkage arm 250. The tapered end 251 of the linkage arm 250 therefore travels from a distal (FIG. 11) to a proximal (FIG. 10) position. In the distal position, the tapered section 251 does not push the tapered ends 252 of the pins 242. In the proximal position, the tapered section 251 pushes on the tapered ends 252 of the pins 242 which makes the pins 242 travel from the retracted configuration to the extended configuration. Resistance is provided by the spring members 264 and the stoppers 254 which ensure that the pins 242 will not travel in the extended or retracted configurations without pressure from the linkage arm 250.

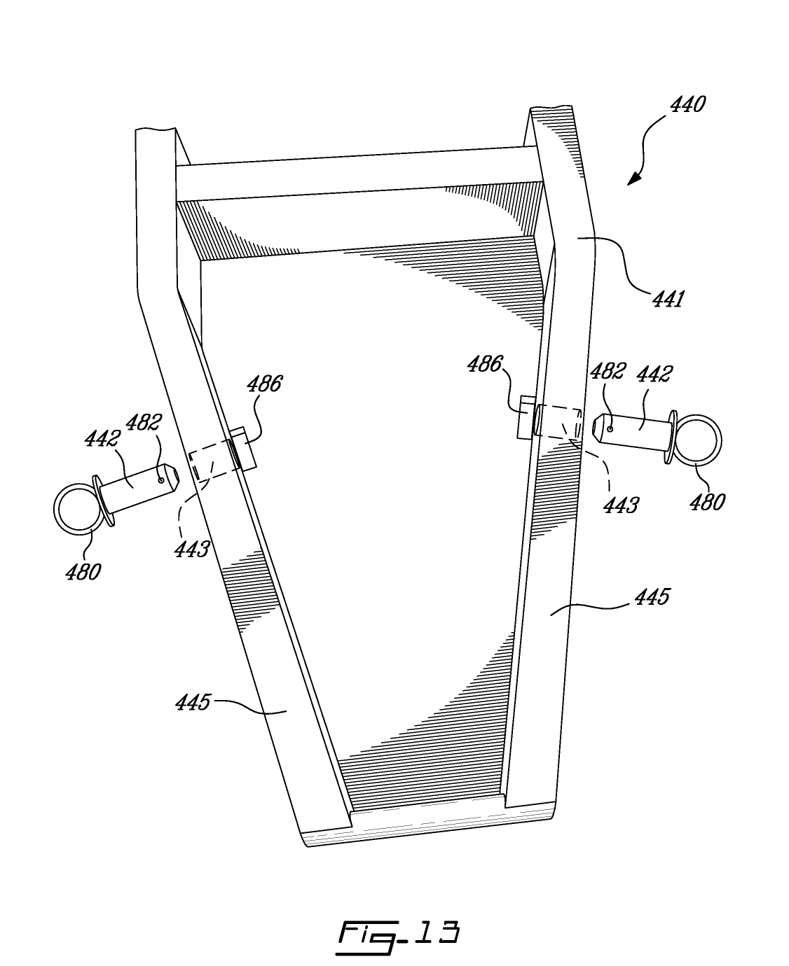

Referring now to FIG. 12, there is shown another alternative embodiment to the couplers 38, 138, 238. The features are numbered with reference numerals which correspond to the reference numerals of the previous embodiment in the 300 series.

In the embodiment shown in FIG. 12, the linkage arm 350 is actuated through a hydraulic or pneumatic cylinder 371, which is mounted rearwardly to the frame 341. In FIG. 12, the pins 342 are in the retracted configuration. The hydraulic or pneumatic cylinder 371 controls the linkage arm 350 via controls 372 which can be remotely controllable by the operator. The linkage arm 350 is operatively connected to the cylinder 371 through aperture 373. The cylinder 371 is used to push or pull linkage arm 350, thereby displacing the pins 342 in the retracted or extended configuration. Once the male portion 340, in the retracted configuration, is inserted in the female portion (not shown) of the coupler 338, the cylinder control 372 is used to place the pins 342 in the extended configuration through apertures 343, 362, thereby securing the coupler 338 in the coupled position. Safety pins are typically not needed with this type of male portion 340 since the cylinder control 372 can exert a constant pressure on the pins 342, preventing them from retracting.

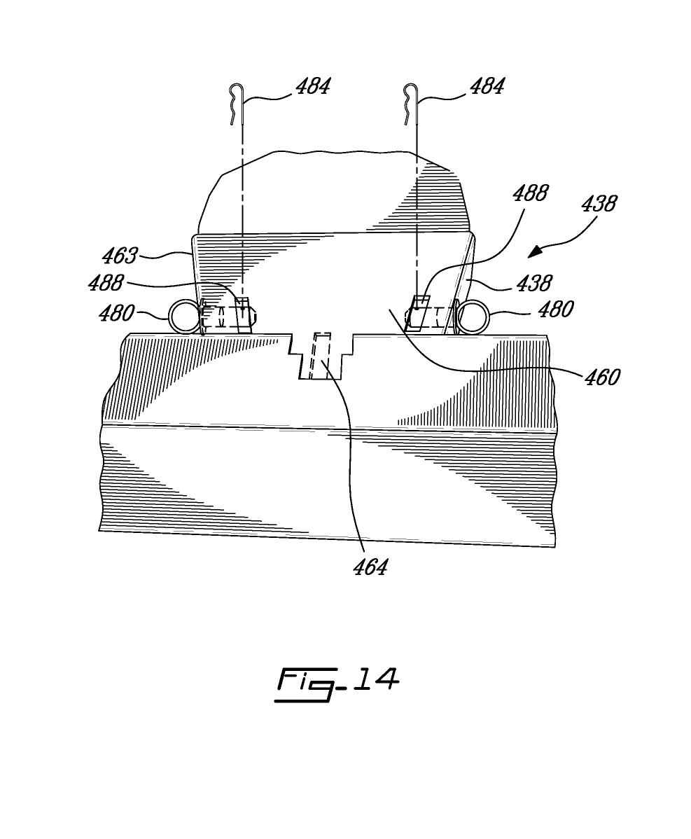

Referring now to FIGS. 13 and 14, there is shown another alternative embodiment to the couplers 38, 138, 238, 338. The features are numbered with reference numerals which correspond to the reference numerals of the previous embodiment in the 400 series.

FIG. 13 shows an alternative male portion 440 of the coupler 438 adapted to receive independent pins 442 from the outside of the frame 441. The pins 442 are provided with a handle 480 to facilitate manipulation by the operator. The pins 442 also bear safety holes 482 adapted to receive safety pins 484. On the inside of the side walls 445 of the male portion 440, aligned with the holes 443, nuts (not shown) can be provided if the pins 442 are threaded. If the pins 442 are not threaded, nuts can still be provided for stability.

FIG. 14 shows the male portion 440 being inserted in the complementary female portion 460 with the independent pins 442 received in both the female and the male portions 440, 460 of the coupler 4387 with safety pins 484 provided through safety apertures 488 of the female portion 460 to secure all items in place. The male portion 440 includes a corresponding aperture 486 (FIG. 13) which is in register with apertures 488 when the male and female portions 440, 460 are engaged. In use, the operator first aligns the male and female portions 440, 460 and ensures both are fully coupled with the apertures 443, 462 in registry. When they are, he inserts pins 442 in holes 443 and 462 using handles 480 and then inserts safety pins 484 through safety apertures 486, 488 in holes 482.

As will be readily understood, the handle, if present, can be provided on either side of the male portion. It could also extend on both sides of the male portion. Similarly, the handle could be provided so that the pins are in the extended configuration when the handle is rotated towards the female portion or, alternatively, the pins could travel to the extended configuration when the handle is rotated away from the female portion towards the vehicle.

As it will be readily understood, the safety mechanism shown to be a safety pin inserted in a hole could be replaced by other safety mechanisms such as a spring loaded push button adapted to be pushed within a piece before displacing the piece and adapted to be released when the push button has traveled within a passage and reached the other side of the passage.

In an embodiment, the pins can include a stopper provided at a rear end thereof. The stopper can be a ring affixed to the rear end of a diameter greater than a diameter of the male pin aperture. Thus, the stopper abuts the male side wall in the extended configuration and prevents the pin from further translating in the extended configuration.

It is appreciated that in alternate embodiments the accessory coupler can include only one pin to secure the male member and the female member in the engaged configuration. The pin can be simultaneously insertable in male and female apertures provided in opposite side walls or the pin can be insertable in only one couple of male and female apertures.

Moreover it is appreciated that the male attachment can be mounted either to the accessory attachment section or the vehicle attachment section. The female attachment is mounted to the other one of the accessory attachment section or the vehicle attachment section.

It is appreciated that the double pin actuator can be replaced with two single pin actuators. Thus, each pin is actuated independently.

The embodiments described above are intended to be exemplary only. The scope of the invention is therefore intended to be limited solely by the appended claims.

What is claimed is:

1. A coupler assembly for coupling an accessory to a vehicle chassis, the coupler assembly comprising:
a male member securable to one of the accessory and the vehicle chassis, the male member having a male frame with male side walls and at least one male aperture defined in each of the side walls;
a female member securable to the other one of the accessory and the vehicle chassis, the female member having a female frame with female side walls and at least one female aperture defined in each of the side walls, the female frame defining a cavity, the male member being at least partially insertable in the cavity with the male side walls and the female side walls being juxtaposed to one another and the male apertures and the female apertures in registry; and
at least one pin insertable in the juxtaposed male and female apertures to secure the male and female members together.

2. A coupler assembly as claimed in claim 1, wherein the at least one pin comprises at least two pins insertable in a respective one of the juxtaposed male and female apertures.

3. A coupler assembly as claimed in claim 2, wherein the male frame has a conical portion and the female frame has a corresponding conical portion, the conical portion of the male frame being at least partially insertable in the conical portion of the female frame.

4. A coupler assembly as claimed in claim 2, comprising a double pin actuator mounted to the male member, operatively connected to the at least two pins and activable to simultaneously displace the at least two pins between an extended configuration wherein said at least two pins extend through a respective one of the male aperture and a retracted configuration wherein said at least two pins are contained within said male frame.

5. A coupler assembly as claimed in claim 4, wherein said double pin actuator comprises a linkage arm having a first end operatively connected to a rear end of said at least two pins and translatable for displacing said at least two pins between said retracted configuration and said extended configuration.

6. A coupler assembly as claimed in claim 5, wherein said double pin actuator comprises a rotatable rod having a handle section and a curved section operatively connectable to the linkage arm, said linkage arm being translated upon rotation of said rotatable rod.

7. A coupler assembly as claimed in claim 5, wherein said double pin actuator comprises two pivoting arms, each having a pivot end pivotably mounted to a single pivot point of said linkage arm and a pin rear end operatively connected to a rear end of one of said at least two pins.

8. A coupler assembly as claimed in claim 5, comprising pin guides for guiding displacement of said at least two pins between said retracted configuration and said extended configuration and linkage arm guide for guiding translation of said linkage arm.

9. A coupler assembly as claimed in claim 5, wherein said double pin actuator comprises one of a hydraulic cylinder and a pneumatic cylinder operatively connected to said linkage arm, said linkage arm being translated upon activation of said cylinder to displace said at least two pins between said retracted configuration and said extended configuration.

10. A coupler assembly as claimed in claim 5, wherein said first end of said linkage arm is tapered and said at least two pins have tapered rear ends slidingly abutting a respective side of said tapered first end, said at least two pins being simultaneously translated between said retracted configuration and said extended configuration upon translation of the linkage arm, said pins being in the retracted configuration when said rear ends abut a tip of said tapered first end and said at least two pins being in the extended configuration when said rear ends abut a base of said tapered first end, opposed to the tip.

11. A coupler assembly as claimed in claim 4, wherein said at least two pins further comprises a safety mechanism at a tip end for securing said at least two pins in the extended configuration.

12. A coupler assembly for coupling an accessory to a vehicle chassis, comprising:
a male member having a male attachment end securable to one of the accessory and the vehicle chassis, a conical male portion having a male enlarged end near the male attachment end and an opposed male tapered end, and two pins slidably mounted to the male member, said male tapered end having male side walls with a male pin aperture defined therein, the pins sliding between a retracted configuration wherein said pins are contained within said conical male portion and an extended configuration wherein a tip end of said pins extends outwardly of said conical male portion through a respective one of said male pin apertures; and
a female member having a female attachment end securable to the other one of the accessory and the vehicle chassis and a conical female portion having a female tapered end near said female attachment end and an opposed female enlarged end, said female tapered end having female side walls with a female pin aperture defined therein, said conical male portion being at least partly receivable in said conical female portion in an engaged configuration wherein said female pin apertures are in registry with a respective one of said male pin apertures, the pins extending through the male and female pin apertures in the extended configuration thereof to secure the male member and the female member together in the engaged configuration.

13. The coupler assembly as claimed in claim 12, wherein said male member further comprises a double pin actuator operatively connected to the pins and displacing simultaneously said pins between said retracted configuration and said extended configuration upon actuation.

14. The coupler assembly as claimed in claim 13, wherein said double pin actuator comprises a linkage arm having a first end operatively connected to a rear end of said pins, opposed to the tip, and translatable in said male member for displacing said pins between said retracted configuration and said extended configuration.

15. The coupler assembly as claimed in claim 14, wherein said double pin actuator comprises a rotatable rod having a handle section and a curved section operatively connected to the linkage arm, said linkage arm being translated upon rotation of said rotatable rod.

16. The coupler assembly as claimed in claim 14, wherein said linkage arm is operatively connected to one of a hydraulic actuator and a pneumatic actuator, said linkage arm being translated upon activation of said actuator.

17. The coupler assembly as claimed in claim 14, wherein said pins are operatively connected to said linkage arm at a single pivot point, proximate to said first end, each of said tip ends being oriented toward a respective male pin aperture.

18. The coupler assembly as claimed in claim 14, further comprising pin guides for guiding displacement between said retracted configuration and said extended configuration.

19. The coupler assembly as claimed in claim 14, further comprising two pivoting arms, each having a pivot end pivotably mounted to a single pivot point of said linkage arm and a pin rear end operatively connected to a respective rear end of one of said pins.

20. The coupler assembly as claimed in claim 14, wherein said first end of said linkage arm is tapered and said pins have rear ends, opposed to said tip ends, slidingly abutting a respective side of said tapered first end, said pins being translated between the retracted configuration and the extended configuration upon translation of the linkage arm, said pins being in the retracted configuration when said rear ends abut a tip of said tapered first end and said pins being in the extended configuration when said rear ends abut a base of said tapered first end, opposed to the tip.

21. The coupler assembly as claimed in claim 20, wherein said rear ends of said pins are tapered.

22. The coupler assembly as claimed in claim 20, further comprising biasing members operatively connected to said pins, said pins being spring loaded.

23. The coupler assembly as claimed in claim 14, further comprising a linkage arm guide for guiding translation of said linkage arm.

24. The coupler assembly as claimed in claim 12, wherein said pins further comprise a stopper at a rear end thereof.

25. The coupler assembly as claimed in claim 24, wherein said stopper is a ring affixed to a rear end of said pin, opposed to the tip end, of a diameter greater than a diameter of said male pin aperture, the stopper abutting said male side wall in the extended configuration.

26. The coupler assembly as claimed in claim 12, wherein said pins further comprise a safety mechanism at said tip end for ensuring a constant position of said pins in the extended configuration of said pins and in the engaged configuration of said male and female members.

27. The coupler assembly as claimed in claim 26, wherein said safety mechanism comprises a safety hole extending through said pin and a safety pin receivable in said safety hole.

28. The coupler assembly as claimed in claim 26, wherein said safety mechanism comprises a spring loaded push button having an inserted configuration wherein said spring loaded push button is inserted in said pin for sliding said pin in said male and female pin apertures and a released configuration wherein said spring loaded push button protrudes outwardly of said pin preventing said pin from sliding in said male and female pin apertures.

29. A coupler assembly for coupling an accessory to a vehicle chassis, comprising
a male portion having a male attachment end and a conical male portion, said male attachment end adapted to be affixed to one of the accessory and the vehicle chassis, said conical male portion having a male enlarged end near the male attachment end and an opposed male tapered end, said male tapered end having male side walls, said male side walls each having a male pin aperture;
a female portion having a female attachment end and a conical female portion, said female attachment end adapted to be affixed to the other one of the accessory and the vehicle chassis, said conical female portion adapted to at least partly receive said conical male portion, said conical female portion having a female tapered end near said female attachment end and an opposed female enlarged end, said female tapered end having female side walls, said female side walls each having a female pin aperture, said female pin aperture of said female side walls adapted to be aligned with said male pin aperture of an adjacent one of said male side walls when said conical male portion is at least partly received in said conical female portion; and
two pins each having a tip end and a rear end, adapted to be displaced from a retracted configuration wherein said pins are one of fully contained within said conical male portion and outside said conical female portion and an extended configuration wherein said tip ends of said pins extend through both said male pin apertures and said female pin apertures when said conical male portion is at least partly received in said conical female portion.

30. An accessorized vehicle comprising:
a vehicle chassis having one of a male member and a female member mounted thereto; and
an accessory having the other one of the male member and the female member mounted thereto; the male member having a male frame with male side walls and at least one male aperture defined in each of the side walls and the female member having a female frame with female side walls defining a cavity and at least one female aperture defined in each of the side walls, the male member being at least partially removably insertable in the cavity in an engaged configuration wherein the male side walls and the female side walls are juxtaposed to one another and the male apertures and the female apertures are in registry, the male and the female members being securable together in the engaged configuration with at least one pin inserted in the juxtaposed male and female apertures.

31. A accessorized vehicle as claimed in claim 31, wherein the at least one pin comprises at least two pins insertable in a respective one of the juxtaposed male and female apertures.

32. A accessorized vehicle as claimed in claim 32, comprising a double pin actuator mounted to the male member, operatively connected to the at least two pins and activable to simultaneously displace the at least two pins between an extended configuration wherein said at least two pins extend through a respective one of the male aperture and a retracted configuration wherein said at least two pins are contained within said male frame.

33. A accessorized vehicle as claimed in claim 33, wherein said double pin actuator comprises a linkage arm having a first end operatively connected to a rear end of said at least two pins and translatable for displacing said at least two pins between said retracted configuration and said extended configuration.

34. A accessorized vehicle as claimed in claim 34, wherein said double pin actuator comprises two pivoting arms, each having a pivot end pivotably mounted to a single pivot point of said linkage arm and a pin rear end operatively connected to a rear end of one of said at least two pins.

35. A accessorized vehicle as claimed in claim 32, wherein said at least two pins further comprises a safety mechanism at a tip end for securing said at least two pins in the extended configuration.

36. A method for coupling an accessory to a vehicle chassis, the method comprising:
securing a male member to one of the accessory and the vehicle chassis, the male member having a male frame with male side walls and at least one male aperture defined in each of the side walls;
securing a female member to the other one of the accessory and the vehicle chassis, the female member having a female frame with female side walls and at least one female aperture defined in each of the side walls, the female frame defining a cavity;
at least partially inserting the male member inside the cavity of the female member with the male side walls and the female side walls being juxtaposed to one another and the male apertures and the female apertures in registry; and
engaging a pin in each of the juxtaposed male and female apertures to secure the male and female members together.

37. A method as claimed in claim 37, further comprising translating a linkage arm mounted to the male member and operatively connected to the pins for simultaneously engaging the pins in each of the juxtaposed male and female apertures to secure the male and female members together.

38. A method as claimed in claim 38, further comprising rotating a rod operatively connected to the linkage arm for translating the linkage arm and for simultaneously engaging the pins in each of the juxtaposed male and female apertures to secure the male and female members together.
